(19) United States
(12) Patent Application Publication
(10) Pub. No.: US 2025/0347314 A1
(43) Pub. Date: Nov. 13, 2025

(54) CONNECTING ELEMENT INCLUDING A SACRIFICIAL BALL JOINT, IN PARTICULAR FOR AN ENGINE SUPPORT

(71) Applicant: SKF Aerospace France S.A.S, Perrigny (FR)

(72) Inventors: Arnaud Jean Auguste TURMEAU, Chabeuil (FR); Aiouba OMAR, Valence (FR); Louis BRIDONNEAU, Peyrins (FR); Anthony Roger Jeannot JÉRÔME, Valence (FR); Maxime MOLLIER, Ozon (FR); Eve GOUJON, Perrigny (FR)

(21) Appl. No.: 19/194,211

(22) Filed: Apr. 30, 2025

(30) Foreign Application Priority Data
May 7, 2024 (FR) 2404804

(51) Int. Cl. F16C 11/06; B64D 27/40

(52) U.S. Cl. CPC F16C 11/06; B64D 27/40

(57) ABSTRACT

A connecting element, in particular for supporting an engine, includes a body, a first ball joint and a second ball joint, each ball joint being mounted on the body. The connecting element further includes a sacrificial third ball joint distinct and separate from the first and second ball joints and supported by the body. The third sacrificial ball joint includes an outer ring having a spherical inner surface and an inner ring having a spherical outer surface, the two spherical surfaces being in contact with each other. An outer ring projects laterally on either side of the body and the connecting element further includes a device for fixing the sacrificial ball joint to the body.

### CROSS-REFERENCE

This application claims priority to French patent application no. 2404804 filed on May 7, 2024, the contents of which are fully incorporated herein by reference.

### BACKGROUND OF THE INVENTION

The present invention relates to the field of connecting elements including ball joints, and more particularly such connecting elements for supporting an engine.

An aircraft engine is generally supported by a pylon that connects the engine to the wing or to the fuselage of the aircraft. The pylon is connected to the engine via connecting elements including ball joints. The ball joints give the system freedom of movement; in particular, the connecting element allows the system to be flexible and thereby accommodate thermal expansion of the engine.

Certain connecting elements comprising two ball joints can rotate without restraint along their axis of elongation, which is orthogonal to the axis of rotation of the ball joints. Such rotation is due to micro-movements and vibrations caused mainly by friction. The connecting element is thus able to move randomly and to collide with surrounding parts, such as the engine suspension yoke. These collisions or impacts between the connecting element and the surrounding parts can lead to wear and failure.

In order to localize such collisions in unloaded zones of a connecting element, “over-thicknesses” may be provided on one of the front surfaces of the body of the connecting element that supports the ball joints. This solution is effective in protecting the body of the connecting element and the ball joints mounted thereon, but not in protecting the surrounding parts.

### SUMMARY OF THE INVENTION

The present invention aims to remedy the drawbacks discussed above.

The present invention relates to a connecting element, in particular for supporting an engine, comprising a body, a first ball joint and a second ball joint, the first and second ball joints being mounted on the body. The connecting element further comprises a sacrificial third ball joint, which is distinct or separate from the first and second ball joints and is supported by the body, and which comprises an outer ring and an inner ring having a spherical inner surface and a spherical outer surface, respectively, in contact with one another. The outer ring projects laterally on either side or face of the body.

According to a general feature, the connecting element further comprises a device for fixing the sacrificial ball joint to the body.

Thus, the outer ring of the third ball joint forms a sacrificial ring which is intended to come into contact with the surrounding part or parts after the connecting element has been assembled. This limits the contact between, on the one hand, the surrounding part or parts and, on the other hand, the body and the first and second ball joints of the connecting element. The outer ring can easily be replaced in the event of wear, without dismantling the connecting element.

Advantageously, the spherical outer surface of the outer ring of the sacrificial ball joint comprises at least one planar face, and preferably two opposing planar faces.

Preferably, at least the outer surface of the outer ring of the sacrificial ball joint includes a bronze coating and/or cobalt alloy coating.

According to one embodiment, the body of the connecting element includes an elongated portion in which the first and second distinct ball joints are located and a protruding portion projecting transversely with respect to the elongated portion and supporting the sacrificial ball joint.

According to one preferred design, the fixing device comprises a threaded shaft, which extends through the inner ring of the sacrificial ball joint and is inserted into a recess in the body, and a clamping washer mounted on the shaft and interposed between the inner ring of the sacrificial ball joint and the body.

According to another design, the fixing device comprises a thread formed on the body, or on a shaft connected to the body, and onto which the inner ring of the sacrificial ball joint is fixed.

The fixing device may further comprise a groove formed on the body or on the shaft in the extension of the thread and inside which a protrusion of the inner ring of the sacrificial ball joint is housed. Alternatively or in combination, the fixing device may further comprise a nut for locking the sacrificial ball joint, the nut being mounted on the body or on the shaft.

Advantageously, the first and second ball joints have two parallel axes of rotation and the sacrificial ball joint comprises an axis of rotation orthogonal to these axes.

Optionally, a first main face of the body comprises a nickel and/or cobalt alloy and an opposing second main face of the body comprises a titanium and/or nickel alloy.

### BRIEF DESCRIPTION OF THE SEVERAL VIEWS OF THE DRAWINGS

Other aims, features and advantages of the invention will become apparent on reading the following description, which is given purely by way of non-limiting examples and with reference to the appended drawings, in which:

FIG. 1 is a perspective view of a connecting element according to a first exemplary embodiment of the invention;

FIG. 2 is a detail view of a ball joint of the connecting element of FIG. 1;

FIG. 3 is a perspective view of the connecting element of FIG. 1;

FIG. 4 is a partial cross-sectional view of the connecting element of FIG. 1;

FIG. 5 is a partial perspective view of the connecting element of FIG. 1 according to one variant; and

FIG. 6 is a partial cross-sectional view of a connecting element of FIG. 1 according to a second exemplary embodiment of the invention.

### DETAILED DESCRIPTION OF THE INVENTION

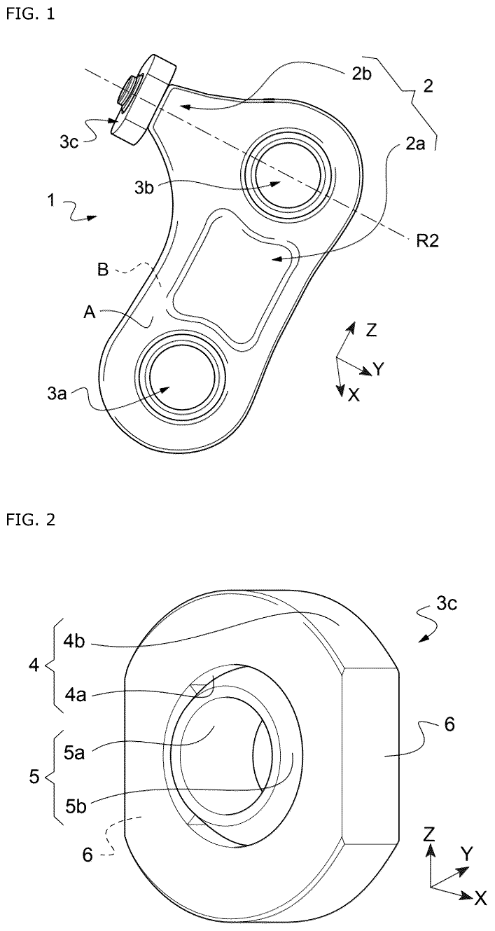

FIG. 1 illustrates a connecting element, denoted by the reference numeral 1, comprising a body 2 and three ball joints 3a, 3b, 3c which are distinct or separate from one another and each mounted on the body 2. The connecting element 1 is represented in an orthonormal reference grid X, Y, Z, in which X denotes the transverse direction of the connecting element 1, the axis Y denotes the direction normal to the transverse axis X and the axis Z denotes the longitudinal direction of the connecting element 1.

The body 2 of the connecting element 1 is provided with two opposing main faces A, B which define its thickness. The body 2 includes an elongated portion 2a which extends in the longitudinal direction Z and a protruding portion 2b projecting transversely in the direction Y with respect to the elongated portion 2a. The elongated portion 2a and the protruding portion 2b define the main faces A and B.

The connecting element 1 includes a first ball joint 3a mounted in a lower zone of the elongated part 2a and a second ball joint 3b mounted in an upper zone of the elongated part 2a. The first and second ball joints 3a, 3b are spaced apart from each other in the longitudinal direction Z. Each ball joint 3a, 3b is mounted inside a separate one of two recesses (not indicated) extending through the body 2. Each one of the first and second ball joints 3a, 3b includes a ring mounted inside the associated recess. Each ball joint 3a, 3b includes a convex spherical outer surface in contact with an inner surface of the associated recess in the body 2.

The connecting element 1 further comprises a third ball joint 3c, designated as a “sacrificial ball joint” 3c, mounted on the protruding part 2b projecting from the body 2 of the connecting element 1. The first and second ball joints 3a, 3b have two parallel axes of rotation R1 extending in the direction X and the sacrificial ball joint 3c has an axis of rotation R2 extending in the direction Y. That is, the first ball joint 3a has an axis of rotation R1 and the second ball joint 3b has an axis of rotation R1 that is parallel to the axis R1 of the first ball joint 3a, and vice-versa. The axis of rotation R2 of the sacrificial ball joint 3c is orthogonal to the axis of rotation R1 of each one of the first and second ball joints 3a, 3b.

As will be described in greater detail below, the connecting element 1 further includes a device for fixing the sacrificial ball joint 3c to the body 2, in particular to the protruding part 2b of the body 2.

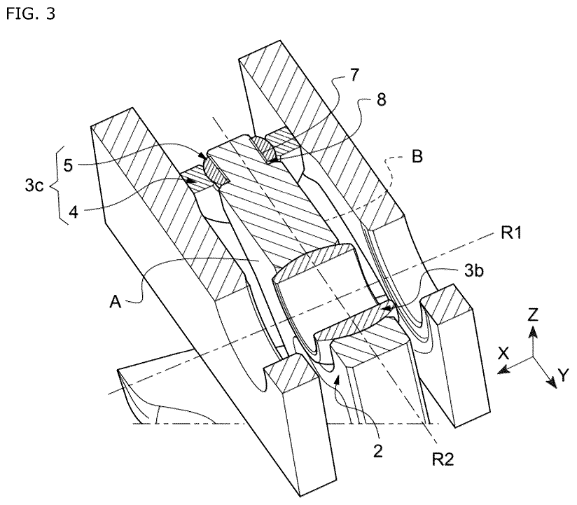

As best shown in FIG. 2, the sacrificial ball joint 3c of the connecting element 1 includes an outer ring 4 and an inner ring 5 in contact with each other.

The outer ring 4 includes a concave spherical inner surface 4a or a bore, an outer surface 4b radially opposing the inner surface 4a, and two opposing radial front faces (not referenced) axially defining or delimiting the inner surface 4a and outer surface 4b.

The inner ring 5 includes a convex spherical outer surface 5b upon which the inner surface 4a of the outer ring 4 is mounted, a cylindrical bore 5a radially opposite to the outer surface 5b, and two opposing radial front faces (not referenced) axially defining or delimiting the bore 5a and the outer surface 5b.

The spherical inner surface 4a of the outer ring 4 and the spherical outer surface 5b surface of the inner ring 5 are in contact with each other and have complementary shapes.

The outer surface 4b of the outer ring 4 of the sacrificial ball joint 3c preferably has two opposing planar faces 6. The planar faces 6 enable a connection of the planar bearing type with the walls of a surrounding part of the engine system, as illustrated in FIG. 3.

The outer ring 4 of the sacrificial ball joint projects laterally on either side or face of the body 2 of the connecting element 1. The outer ring 4 projects laterally on either side of the body 2 in the direction Y. Specifically, the outer ring 4 projects on one side with respect to the main face A of the body 2 and also projects on the other side with respect to the opposing main face B of the body 2.

The outer ring 4 thus forms a sacrificial ring which is designed to come into contact with the walls of the surrounding part of the engine system so as to avoid contact between such a surrounding part and the body 2 and/or the first and second ball joints 3a, 3b.

Advantageously, the outer surface 4b of the outer ring 4 of the sacrificial ball joint 3c has a bronze coating and/or cobalt alloy coating.

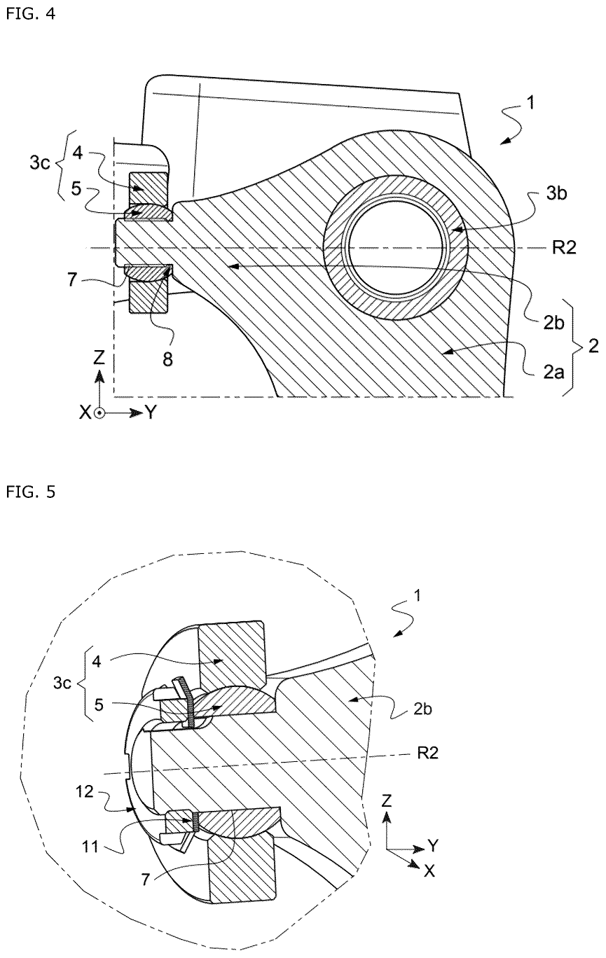

In the exemplary embodiment illustrated in FIGS. 1, 3 and 4, the device for fixing the sacrificial ball joint 3c to the body 2 includes a thread 7 formed on the body 2. The thread 7 is formed on the protruding part 2b of the body 2. The inner ring 5 of the sacrificial ball joint 3c is fixed by screwing onto the thread 7 and for this purpose includes a corresponding tapping or thread in its bore 5a.

The fixing device preferably further includes a groove 8 formed on the body 2 in the extension of the thread 7 and inside of which a protrusion of the inner ring 5 of the sacrificial ball joint 3c is disposed or housed. The groove 8 thereby enables the inner ring 5 of the sacrificial ball joint 3c to be clipped onto the body 2.

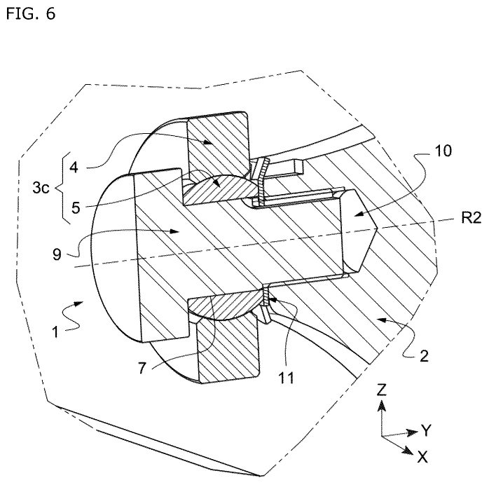

In a variant illustrated in FIG. 5, the fixing device further includes a nut 12 for locking the sacrificial ball joint 3c, the nut 12 being mounted onto the thread 7 of the body 2. In this case, the bore 5a of the inner ring 5 does not require a thread and the fixing device does not need a groove 8. Preferably, the fixing device depicted in FIG. 5 further includes a clamping washer 11 mounted on the thread 7 of the body 2 and interposed between the inner ring 5 of the sacrificial ball joint 3c and the nut 12. The nut 12 and the clamping washer 11 enables locking of the inner ring 5 of the sacrificial ball joint 3c against the body 2 and thereby locks the sacrificial ball joint 3c against the body 2.

In the two embodiments described above, the thread 7 of the fixing device is formed directly on the body 2. Alternatively, it is possible to provide the thread on a shaft connected to the body 2.

In the exemplary embodiment illustrated in FIG. 6, in which identical elements bear the same references, the device for fixing the sacrificial ball joint 3c to the body 2 includes a threaded shaft 9 connected to the body 2 which extends through the bore 5a of the inner ring 5 of the sacrificial ball joint 3c. The protruding portion 2b of the body 2 of the connecting element 1 includes a recess 10 into which the threaded shaft 9 may be force-fitted. In this embodiment, the fixing device further includes a clamping washer 11 mounted on the shaft 9 and interposed between the inner ring 5 of the sacrificial ball joint 3c and the body 2 of the connecting element 1. The clamping washer 11 is engaged inside a groove (not referenced) formed on the threaded shaft 9.

According to one embodiment, the first main face A of the body 2 may have a layer of coating of nickel and/or cobalt alloy resistant to the high temperatures generated by combustion within the engine and the opposing second main face B of the body 2 may have a titanium and/or nickel alloy layer/coating.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A connecting element for supporting an engine, the connecting element comprising:
a body having two opposing sides;
a first ball joint mounted on the body;
a second ball joint mounted on the body and spaced from the first ball joint;
a sacrificial third ball joint separate from the first and second ball joints and supported by the body, the sacrificial ball joint including an outer ring having a spherical inner surface and an inner ring having a spherical outer surface in contact with the spherical outer surface of the outer ring, the outer ring projecting laterally outwardly from each side of the body; and
a fixing device for connecting the sacrificial ball joint to the body.

2. The connecting element according to claim 1, wherein the outer ring of the sacrificial ball joint has an outer surface with at least one planar face.

3. The connecting element according to claim 1, wherein the outer ring of the sacrificial ball joint has an outer surface with two opposing planar faces.

4. The connecting element according to claim 1, wherein at least the outer spherical surface of the outer ring of the sacrificial ball joint includes a bronze coating and/or cobalt alloy coating.

5. The connecting element according to claim 1, wherein the body of the connecting element includes an elongated portion, the first and second ball joints being located on the elongated portion, and a protruding portion projecting transversely with respect to the elongated portion and supporting the sacrificial ball joint.

6. The connecting element according to claim 1, wherein the fixing device includes:
a threaded shaft extending through the inner ring of the sacrificial ball joint and inserted into a recess in the body; and
a clamping washer mounted on the shaft and interposed between the inner ring of the sacrificial ball joint and the body.

7. The connecting element according to claim 1, wherein the fixing device includes a thread formed on the body or on a shaft connected to the body, the inner ring of the sacrificial ball joint having a thread engaged with the thread of the fixing device.

8. The connecting element according to claim 7, wherein the fixing device further includes a groove formed on the body or on the shaft connected to the body, the inner ring of the sacrificial ball joint having a protrusion disposed within the groove.

9. The connecting element according to claim 7, wherein the fixing device further includes a nut for locking the sacrificial ball joint, the nut being mounted on the body or on the shaft.

10. The connecting element according to claim 1, wherein the first ball joint has an axis of rotation, the second ball joint has an axis of rotation, the two axes of rotation of the first and second ball joints being parallel, and the sacrificial ball joint has an axis of rotation extending orthogonal to the two axes of rotation of the first and second ball joints.

11. The connecting element according to claim 1, wherein:
a first main face of the body has a nickel alloy and/or a cobalt alloy; and
an opposing, second main face of the body has a titanium alloy and/or a nickel alloy.
